(19) United States
(12) Patent Application Publication
(10) Pub. No.: US 2008/0095220 A1
(43) Pub. Date: Apr. 24, 2008

(54) Circuit Arrangement for Suppressing Interfering Signals in the Receiving Branch of a Modem of a Household Appliance

(75) Inventors: Udo Hertel, Regensburg (DE); Simon Piermeier, Regensburg (DE); Roman Makhthyuk, Alteglofsheim (DE)

Correspondence Address: LERNER GREENBERG STEMER LLP, P O BOX 2480, HOLLYWOOD, FL, 33022-2480, US

(73) Assignee: BSH Bosch und Simens Hausgerate GmbH

(21) Appl. No.: 11/660,237

(22) PCT Filed: Aug. 2, 2005
(86) PCT No.: PCT/EP05/53754

§ 371 Date: May 10, 2007

(30) Foreign Application Priority Data
Aug. 13, 2004 (DE) 10 2004 039 396.6

(51) Int. Cl. H04L 25/02

(52) U.S. Cl. 375/222

(57) ABSTRACT

A circuit arrangement for suppressing interfering signals in the receiving branch of a modem containing a transmitting branch and the receiving branch, of a household appliance equipped with a transmitting device for transmitting and a receiving device for receiving data signals. When using a receiving circuit of the modem with an input circuit having a relatively high input impedance compared with the impedance of a useful signal source delivering data signals, to which data signals are supplied by the useful signal source having a relatively low impedance in comparison and in the presence of the interfering signal sources which deliver the interfering signals which have a relatively high impedance, an ohmic resistance is connected in parallel to the input circuit with a relatively low resistance compared to the input impedance.

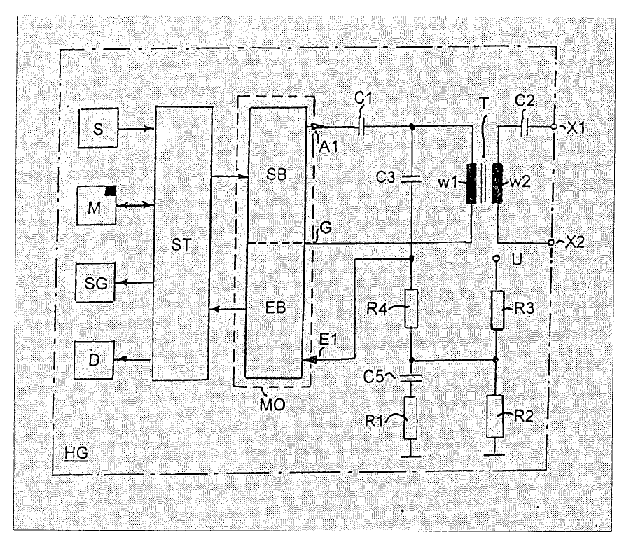

The invention relates to a circuit arrangement for suppressing interfering signals in the receiving branch of a modem of a household appliance equipped with a transmitting device for transmitting and a receiving device for receiving data signals, said modem containing a transmitting branch and a receiving branch.

In a known circuit arrangement for transmitting data signals from and/or to household appliances (U.S. Pat. No. 6,590,493 B1), in each case one group of individual household appliances is connected to a mains AC voltage line arrangement via a separate filter arrangement. The filter arrangements of different groups of household appliances are dimensioned so that the data signals transmitted in one group of household appliances cannot reach the household appliances belonging to a different group of household appliances. LC low-pass filters having different configurations are used for the relevant filter arrangements. In this connection, no further details are known about measures for eliminating or suppressing interfering signals which appear in the receiving branch of the respective household appliance.

In another known circuit arrangement for transmitting data signals from and/or to household appliances (U.S. Pat. No. 6,396,392 B1), the respective transmitting/receiving device comprises a modem connected to the respective household appliance which is connected to the mains AC circuit arrangement by means of a coupler. Various filters such as low-pass filters and band-pass filters are contained in the modem and in the coupler. In this connection also, no further details are known about measures for suppressing interfering signals which appear in the receiving branch of the respective modem.

Finally, a communication system working with a data modem is also known (DE 38 30 338 C2) wherein undesirable signal frequencies of a so-called secondary channel (300 to 350 Hz band) are suppressed in the respective modem receiving branch by means of a suppression filter and only a so-called main channel signal is transmitted in a frequency band of 600 to 3000 Hz. Although nothing is known in this connection about the suppression of interfering signals in the receiving branch of the respective data modem, the relevant circuit measure, namely the use of a suppression filter for a certain frequency range could also be used to suppress interfering signals which occur at a frequency different from a useful signal receiving frequency. If such interfering signals with frequencies above and below a useful signal receiving frequency are to be taken into account, however a plurality of correspondingly dimensioned suppression filters should be provided which means a not inconsiderable expenditure on circuitry, which should actually be avoided.

In a modem of the type specified initially, interfering signals pose considerable problems even when they are output by relatively high-impedance interfering signal sources (e.g. with Ri>10 kΩ or >100 kΩ) when a transmitting/receiving IC module is used in the relevant modem whose receiving branch is relatively broad-band and high-impedance and has an input impedance of, for example, 150 kΩ. These conditions apply, for example, to the ST7538 IC module from STMicroelectronics which is provided for use as a transmitting/receiving module in a modem of a household appliance. If interfering signals from relatively high-impedance interfering signal sources occur in the receiving branch of such a module, unless separate measures are taken, these interfering signals would block the input circuit in the receiving branch of the relevant IC module to a certain extent so that the actual useful signal could no longer be recognised by the relevant receiving branch, although it optionally occurs at a useful signal frequency different from the interfering signal frequencies, and is output by a relatively low-impedance useful signal source (e.g. with Ri=1Ω).

Interfering signals of the type mentioned previously can comprise pulsed interfering signals which occur on the respective modem receive line, which are supplied from other appliances, but possibly are also produced in the household appliance containing the relevant modem, as well as low-frequency interfering signals which occur at frequencies of n times the mains AC frequency, where n≧1. The afore-mentioned pulsed interfering signals can comprise, for example, harmonics of the switching frequency of a switching power supply for the modem of a household appliance. For example, if the switching mains frequency is 44 kHz, the frequency of the third harmonic of this switching frequency is 132 kHz; it is thus quite clearly in the frequency range of the CENELEC band C (125-140 kHz) which is specified for so-called power-line communications, that is for power line communication in Europe.

In order to suppress such interfering signals in a circuit arrangement of the type specified initially, when using a receiving circuit of the modem with an input circuit having a relatively high input impedance, it has already been proposed (DE Patent Application of the Applicant dated Nov. 8, 2004) to connect a bandpass filter in parallel with said input circuit, its resonance frequency being set at such a value that the frequency of the respective interfering signal lies either above or below the relevant resonance frequency.

Although the circuit arrangement which has already been proposed is capable of effecting excellent suppression of interfering signals of the type considered, it is desirable however to further reduce the circuitry expenditure required for implementing the relevant circuit arrangement and to achieve a result with regard to the suppression of interfering signals which corresponds to or at least comes close to that which can be achieved with the aforementioned circuit arrangement which has already been proposed.

It is thus the object of the invention to further develop a circuit arrangement of the type specified initially in such a manner that interfering signals occurring in the receiving branch of said modem can be effectively suppressed with an even lower expenditure on circuitry than in the aforementioned circuit arrangement which has already been proposed, which signals are coupled into said receiving branch of the modem or fed thereto electrically and/or magnetically from relatively high-impedance interfering signal sources.

The object indicated hereinbefore is achieved in a circuit arrangement of the type specified initially according to the invention whereby when using a receiving circuit of the modem with an input circuit having a relatively high input impedance, an ohmic resistance having a relatively low resistance value is connected in parallel to said input circuit.

The invention has the advantage that with a lower expenditure on circuitry compared with the aforementioned circuit arrangement which has already been proposed, namely merely by connecting an ohmic resistance in parallel to the input circuit of said receiving circuit of the modem, the circuit input of the receiving circuit of the modem having a relatively high input impedance (of, for example, about 150 kΩ) has a relatively low impedance (of, for example, 1 kΩ) in the frequency range of the interfering signals. As a result, on account of the afore-mentioned low impedance of the circuit input of the receiving device of the modem, interfering signals originating from relatively high-impedance interfering signal sources (e.g. with Ri>10 kΩ or >100 kΩ) are reduced in their voltages and thus can no longer disadvantageously influence the receiving branch of the afore-mentioned modem; they are therefore sufficiently suppressed. In addition, in particular in cases where the relevant interfering signals originate from the household appliance or the modem or the power supply unit for the modem and are coupled capacitively and/or magnetically into the receiving circuit of the modem, expensive shielding measures at transmitters or in the receiving branch of the modem and the use of magnetically shielded components and/or shielding sheets which are otherwise required, can be eliminated.

In other words, this means that the effect is advantageously used according to the invention that merely by connecting a relatively low-impedance component, in this case, an ohmic resistance in parallel to the input circuit of the receiving circuit of the modem, this input circuit is made so low-impedance that as a result, the voltages of the relevant interfering signals coupled into the signal input of the input circuit of the modem by relatively high-impedance interfering signal sources are reduced and thus no longer block the receiving circuit of the modem. The useful signals supplied by a relatively low-impedance useful signal source (e.g. with Ri=1Ω) can thus even be recognised by the relevant receiving circuit of the modem and received if they appear at the same frequency as the interfering signals.

Said ohmic resistance is appropriately capacitively coupled to the receiving branch of the modem. This yields the advantage that effective direct-current decoupling of said ohmic resistance from the relevant receiving branch of the modem is particularly easy to implement.

A DC voltage which determines the working point of the receiving circuit is preferably supplied to the ohmic resistance at its end facing away from the end connected to the receiving branch of the receiving circuit. This measure results in the advantage of a particularly simple adjustment of the working point of the afore-mentioned receiving circuit of the modem even in the circuit arrangement which has already been proposed and specified initially and at the same time, results in a desirable influencing of the input impedance of the relevant receiving circuit of the modem.

A tap of an ohmic voltage divider located between a supply voltage and a reference potential, in particular earth potential, is preferably used to provide the afore-mentioned DC voltage. This yields the advantage of a particularly simple provision of the afore-mentioned DC voltage.

A particularly favourable circuit structure is obtained if said ohmic resistance with its end facing away from the end connected to a signal input connection of the receiving circuit of the modem lies at a reference potential, in particular earth potential, via an additional capacitor and an additional ohmic resistance located in series therewith. This circuit measure can advantageously rapidly compensate for any oscillation which occurs during the switching process from transmitting operation to receiving operation and at the same time, said ohmic resistance is decoupled in terms of DC voltage from the DC voltage source providing the working point of the receiving circuit of the modem. In addition, said ohmic resistance is effectively connected in parallel in terms of AC current to the input circuit of the relevant receiving circuit of the modem via the series circuit comprising said additional capacitor and said additional ohmic resistance.

As an additional effective measure for suppressing interfering signals in the receiving branch of a modem of the type considered hereinbefore, it has proved to be particularly advantageous when using a transmit/receive IC module in the relevant modem or as its transmitting and receiving circuit if all the connections of the relevant IC module not required for the transmitting and receiving operation of the modem are set at a defined potential. This measure which supplements the preceding measure has the result that no interfering signals can be coupled into the receiving branch of the modem via connections of the relevant IC module not required for the relevant transmitting and receiving operation. In order to set the connections of the aforementioned IC module not required for the transmitting and receiving operation of the relevant modem at a defined potential, the procedure can be followed, for example, that the relevant connections are each set to a particular potential such as the supply voltage potential or earth potential by means of so-called pull-up resistances or pull-down resistances or are even connected directly to earth of the circuit arrangement.

An exemplary embodiment of the circuit arrangement according to the present invention is explained in detailed hereinafter with reference to a drawing.

Shown schematically in the drawing is a household appliance HG which is equipped with a circuit arrangement for suppressing interfering signals in the receiving branch of a modem MO, containing a transmitting branch and the receiving branch of a household appliance HG equipped with a transmitting device for transmitting and a receiving device for receiving data signals. The relevant household appliance HG can be any networkable household appliance such as a washing machine, a drier, a cooker, a refrigerator, a heating system etc. A networkable household appliance is understood here as a household appliance which can be connected by means of a transmitting and/or receiving device to a communication network for transmitting various data signals. In the present case, this communication network comprises the AC voltage network from which the supply voltages required for the operation of the respective household appliance are taken. However, it is naturally also possible to use any other network, such as the internet, as the communication network.

The circuit arrangement shown in the drawing contains the modem MO having a transmitting branch and a receiving branch, which in the present case is shown as containing a transmitting module or a transmitting circuit SB and a receiving module or a receiving circuit EB. These modules or circuits SB and EB can comprise a combined commercial transmit-receive module (for example, the mains lead FSK transmit-receive module ST7538 from STMicroelectronics already mentioned in the introduction—see the publication of this company dated June 2003).

Connected to the afore-mentioned modem MO is a control device ST, which in this case belongs to a transmitting device and a receiving device of the circuit arrangement. In the present case, in addition to the control device ST, the transmitting device of the relevant circuit arrangement comprises one or more sensors S provided in the household appliance HG, for example, to detect one or more parameters of state of the household appliance HG and a memory M in which data signals can be stored in the form of status signals and/or working programs of the relevant household appliance HG. In addition to the control device ST, the receiving device of the relevant circuit arrangement comprises, for example, one or more control elements SG, a display device D, such as an LCD display device, for example, and the previously mentioned memory M. Data signals can be sent to the relevant control elements SG in the afore-mentioned receiving branch; data signals transmitted in the receiving branch can also be stored in the afore-mentioned memory M and displayed by the display device D. The data signals transmitted in the receiving branch can, for example, comprise test signals in the course of carrying out remote diagnoses or new working programs or parts thereof for updating the working programs of the household appliance HG stored in the afore-mentioned memory M.

A matching transformer T comprising a winding w1 and a capacitor C1 is connected between a signal output connection A1 of the transmitting unit SB and a reference potential connection G, which carries earth potential for example, and which is provided jointly for the transmitting unit SB and the receiving unit EB. The matching transformer T comprises a further winding w2 which is firstly connected to a connection x1 via a capacitor C2 and secondly directly to a connection x2 of the circuit arrangement shown. The two windings w1 and w2 of the matching transformer T can have a winding ratio of 1:1. The afore-mentioned communication network will be or is connected to the connections x1, x2.

According to the present invention, an ohmic resistance R4 of, e.g. 1 kΩ is connected capacitively, namely via a coupling capacitor C3 to the connection point between the capacitor C1 and one end of the winding w1 of the matching transformer T—the circuit part comprising the aforementioned connection point represents a transmitting branch and a receiving branch of the modem MO. In the present case, this ohmic resistance R4 lies at a reference potential, preferably at earth potential via a capacitor C5 and an additional ohmic resistance R1 connected in series thereto. The connection point between the afore-mentioned coupling capacitor C3 and the ohmic resistance R4 is connected to the afore-mentioned signal input connection E1 of the receiving module EB. The relevant ohmic resistance R4 thus does not lie in the lead-in path but in the lead-out path of the relevant receiving branch of the receiving module or the receiving circuit EB of the modem MO—it therefore lies parallel to the input circuit of the receiving branch or the receiving circuit of the receiving component EB of the modem MO in terms of AC current.

In the present case, a DC voltage which determines the working point of the receiving module EB of the modem is supplied via the aforementioned ohmic resistance R4. In the present case, this DC voltage is provided by the tap of an ohmic voltage divider consisting of the ohmic resistances R2 and R3 which lie between a connection U carrying a supply voltage of 5 V, for example, and a connection carrying an earth potential.

It should be noted at this point that the working point of the receiving module EB can be set in a desired range by suitable selection of the resistance values of the afore-mentioned resistances R2 and R3; the relevant working point can be set, for example, to a point midway between the supply voltage at the connection U and earth by uniformly high values of the resistances R2 and R3, which is particularly desirable with regard to the controllability of the receiving module EB by useful signals, which occur, for example, with positive and negative useful signal level components running about a zero level. In terms of AC current, this ohmic voltage divider consisting of the ohmic resistances R2 and R3 has no influence on the efficiency of the parallel connection of the ohmic resistance R4 to the input circuit of the aforementioned modem. In addition, as has already been mentioned, the ohmic resistance is decoupled in terms of DC current by the capacitors C3 and C5.

The structure of the circuit arrangement shown in the drawing according to one embodiment of the present invention, which has been described hereinbefore, ensures that interfering signals from relatively high-impedance interfering signal sources are effectively suppressed in the receiving branch of the modem MO. The ohmic impedance R4 used in the relevant circuit arrangement only allows the useful signal delivered by a low-impedance useful signal source with the useful signal receiving frequency to carry through to the input connection E1 of the receiving module EB of the modem MO, whilst interfering signals from relatively high-impedance interfering signal sources (see introduction) are so severely damped by the input circuit of the modem MO which has been made low-impedance by means of said ohmic resistance R4 that they can no longer have any perturbing effect on the receiving module EB of the modem; the relevant interference voltages are reduced to a certain extent as a result of the low impedance thereby imparted to the input connection E1 of the receiving module EB by the relevant ohmic resistance R4 and can no longer perturb the reception of the useful signal by the receiving module EB. Thus, the immunity of the modem MO to interference is increased or its reachability for useful signals in a perturbed environment is improved in a simple manner, namely by using few discrete components. In addition the standard EN 61000-4-4 can be simply adhered to with regard to fast pulsed burst signals.

The useful signals which, as has been mentioned at the beginning, are usually from relatively low-impedance useful signal sources (with, for example, Ri=1Ω) and are transmitted over likewise relatively low-impedance transmission distances (with, for example Rt<1Ω) are easily recognised in the receiving module EB of the modem MO.

Finally, it should be noted that only one useful signal receiving frequency has been discussed in each case hereinbefore. However, it is understood that the present invention can naturally also be applied to a circuit arrangement in which interfering signals from relatively high-impedance interfering signal sources are to be suppressed which occur within or outside a useful signal receiving frequency range comprising a plurality of useful signal frequencies in a cohesive frequency range or in various frequency partial ranges.

### REFERENCE LIST

A1 Signal output connection
C1 Capacitor
C2 Capacitor
C3 Coupling capacitor
C4 Capacitor
D Display device
E1 Signal input connection
EB Receiving unit, receiving circuit
G Reference potential connection
HG Household appliance
M Memory
MO Modem
R1 Ohmic resistance
R2 Ohmic resistance
R3 Ohmic resistance
R4 Ohmic resistance
S Sensors
SB Transmitting unit, transmitting circuit
SG Control elements
ST Control device
T Matching transformer
U Connection
w1 Winding
w2 Winding
x1 Connection
x2 Connection

1-6. (canceled)

7. In a household appliance equipped with a transmitting device for transmitting data signals and a receiving device for receiving data signals and having a modem with a transmitting branch and a receiving branch, a circuit arrangement for suppressing interfering signals in the receiving branch of the modem, comprising:
a receiving circuit of the modem connected via an input circuit having a relatively high input impedance compared with an impedance of a useful signal source delivering the data signals, said input circuit receiving the data signals from a useful signal source having a relatively low impedance in comparison; and wherein interfering signal sources deliver interfering signals having a relatively high impedance;
an ohmic resistance connected in parallel with said input circuit, said resistance having a relatively low resistance compared to the input impedance.

8. The circuit arrangement according to claim 7, which further comprises a capacitance capacitively coupling said ohmic resistance to the receiving branch of the modem.

9. The circuit arrangement according to claim 8, wherein said ohmic resistance is connected, at a terminal thereof opposite from a terminal connected to the receiving branch of the receiving circuit, to receive a DC voltage determining a working point of the receiving circuit.

10. The circuit arrangement according to claim 9, which comprises an ohmic voltage divider connected between a supply voltage and a reference potential, said voltage divider having a center tap carrying the DC voltage connected to said ohmic resistance.

11. The circuit arrangement according to claim 10, wherein said ohmic voltage divider is connected between the supply voltage and ground.

12. The circuit arrangement according to claim 7, wherein said ohmic resistance has a first terminal connected to the receiving branch of the receiving circuit and a second terminal opposite connected to a reference potential.

13. The circuit arrangement according to claim 12, wherein said second terminal of said ohmic resistance is connected to ground.

14. The circuit arrangement according to claim 12, which further comprises a series circuit of a capacitor and an ohmic resistor connected between said second terminal of said ohmic resistance and the reference potential.

15. The circuit arrangement according to claim 7, wherein the transmit circuit and the receive circuit of the modem are implemented in a transmit/receive IC module, and wherein all connections of the IC module not required for transmit and receive operation of the modem are set at a defined potential.

16. A communications device for a household appliance, comprising:
a transmitting device for transmitting data signals and a receiving device for receiving data signals;
a modem having a transmitting branch and a receiving branch; and
a circuit arrangement for suppressing interfering signals in said receiving branch of said modem, wherein a receiving circuit of said modem is connected via an input circuit having a relatively high input impedance compared with an impedance of a useful signal source delivering the data signals, said input circuit receiving the data signals from a useful signal source having a relatively low impedance in comparison, and wherein interfering signal sources deliver interfering signals having a relatively high impedance, and an ohmic resistance connected in parallel with said input circuit, said ohmic resistance having a relatively low resistance compared with the input impedance.
